(19) United States
(12) Patent Application Publication
(10) Pub. No.: US 2005/0041861 A1
(43) Pub. Date: Feb. 24, 2005

(54) Arrangement and method for controlling and operating a microscope

(75) Inventor: Frank Olschewski, Heidelberg (DE)

Correspondence Address: HOUSTON ELISEEVA, 4 MILITIA DRIVE, SUITE 4, LEXINGTON, MA, 02421, US

(73) Assignee: Leica Microsystems Heidelberg GmbH, Mannheim (DE)

(21) Appl. No.: 10/917,174

(22) Filed: Aug. 12, 2004

(30) Foreign Application Priority Data
Aug. 22, 2003 (DE) DE 103 38 590.8

(51) Int. Cl. G06K 9/34

(52) U.S. Cl. 382/180

(57) ABSTRACT

As a user works at a microscope, image details are constantly present in the user's field of view. The user usually analyzes those image details, marks them with a suitable graphical software mechanism on the screen, and selects a desired function. According to the present invention, the user is offered a user interface that is based substantially on the user's knowledge of the world. A suitable combination of automated adjustment operations, automatic and semiautomatic image analysis, appropriate visualization technology, and integration is automatically used for image depiction.

### RELATED APPLICATIONS

This application claims priority of the German patent application 103 38 590.8 which is incorporated by reference herein.

### FIELD OF THE INVENTION

The invention concerns an arrangement for controlling and operating a microscope, as defined in the preamble of Claim 1; and a method for controlling and operating a microscope, as defined in the preamble of Claim 8. The invention furthermore concerns a software program on a data medium for controlling an operating a microscope, as defined in the preamble of Claim 13.

### BACKGROUND OF THE INVENTION

As a user works at a microscope, image details (differing depending on the application) are constantly present in the user's field of view. In present-day systems, the user analyzes those image details, marks them with a suitable graphical software mechanism on the screen, and selects a desired function. These functions can serve for further structural investigation of the object. The publication of Wedekind P., Kubitschek U., Peters R., “Scanning microphotolysis: A new photobleaching technique based on fast intensity modulation of a scanned laser beam and confocal imaging,” in Journal of Microscopy, Vol. 176, Pt. 1, October 1994, pp. 23-33, for example, discloses a capability for superimposing geometrical elements on an acquired image of a object. The regions thereby defined are illuminated differently on the object and, as a result of the energy transport associated therewith, bring about changes in the sample. The publication of Demandolx D., Davoust J., “Multicolor analysis and local image correlation in confocal microscopy,” Journal of Microscopy, Vol. 185, Pt. 1, January 1997, pp. 21-36, discloses a plurality of analytical methods in scanning microscopy. The individual analyses require both a geometrical selection of the object to be analyzed, and geometrical selections in a special analysis space (the cytofluorogram). DE 100 41 165 discloses a method for controlling analytical and adjustment processes of a microscope. A high degree of automation can be achieved here because the interaction between the user and the microscope is limited to a minimum, and good-quality results are nevertheless quickly obtained. This is achieved by the fact that any desired input unit is coupled to a special image analysis system. Using an automatic system, it is thereby possible to ascertain what decision the user is making, i.e. which further analysis capability is being selected by the user.

If a variety of users active in microscopy are considered, it is apparent that the distinction made by those users between system-independent and system-dependent knowledge is not consistent. Most users describe their activity as “seeing and manipulating objects under the microscope,” and not as “adjusting the microscope.” This small but (in this case) critical difference results in a conflict that on occasion leads to gross operating errors. The human-machine interaction can be described in general as a triangular relationship among the user, his or her task, and the tool being used, i.e. the microscope.

### SUMMARY OF THE INVENTION

In order to rule out operator errors to the greatest extent possible, it is the object of the present invention to eliminate the “tool” properties of the microscope system to the greatest extent possible.

According to the present invention, this object is achieved by an arrangement for controlling and operating a microscope, in particular for analysis and adjustment operations, the arrangement comprises:
a plurality of detectors for converting optical signals into electrical signals;
a unit for image acquisition;
a segmentation unit for segmenting the images into individual regions, in particular according to color, intensity, or texture;
a unit for labeling the regions;
a geometry unit for separating the segmented and optionally labeled image into individual geometries;
a unit for generating an object-oriented description of the regions, wherein the units being coupled to one another in such a way that the object-oriented representation of the regions is accomplished automatically in accordance with a defined stipulation of the user.

The object is achieved in terms of method for controlling and operating a microscope, in particular analysis and adjustment operations, comprises the steps of:
providing a user input according to which an image of an object is automatically depicted;
segmenting individual regions according to color intensity, or texture;
optionally labeling the segmented regions; and
creating an object-oriented representation of the regions.

The object is as well achieved by a software program on a data medium for controlling and operating a microscope,
wherein upon a defined stipulation of a user, the following processes are automatically performed:
imaging;
segmentation;
optionally, labeling;
object-oriented representation.

The object is thus achieved, fundamentally, by the fact that the user is offered a user interface that is based substantially on the user's knowledge of the world. This requires a consistent conceptual design of the user interfaces with which all microscope operations are performed by defining objects and performing operations on those objects. From the user's viewpoint, it is substantially the objects that he or she sees in the image. They are then displayed by way of a suitable combination of automated adjustment operations, automatic and semiautomatic image analysis, appropriate visualization technology, and integration.

The essence of the manner in which the object is achieved is thus that the user interface and the necessary human-computer interaction (HCI) are cognitively adapted to human cognition, i.e. knowledge. The user interface is the portion of the overall system's interaction interface that is visible to the user. This user interface depends to a certain extent on the microscope system and, of course, depends directly on the application software that is used. The human-computer interface (HCI) is a reciprocal information exchange between the user and the system; by its nature it is rule-based and formalized, but in modem interactive systems at least, control generally lies with the user. The “user interface” or “utilization interface” is understood to mean those parts of a computer system that the user acts on and manipulates in order to get the computer to do what he or she wants. What is really important, however, is the information that is exchanged between the user's world, his or her task, and the system. The quality of the interface is determined by how easily and compatibly that exchange functions. The user's system-independent and also system-specific knowledge must therefore be understood as important criteria for configuring the user interface. The user's cognitive skills furthermore play an essential role when using the computer system.

A number of different and independent implementation capabilities, having substantially the same effect, exist for the technology usable in this context. The general configuration of each mechanism for a method of this kind comprises a network of processing units, for example an adjustment apparatus for the automation function, mouse cursor-object matching, preprocessing, segmentation, generation of geometric models from the image, manipulation of geometric models, distribution of geometric models to lower-order system components of the microscope. The purpose of a preprocessing function, for example, is to filter an acquired image to greatly improve signal-to-noise ratios within the scene. Any low-pass filter (phase-stable, if possible), for example an averaging, binomial, Gaussian, or wavelet-based filter, is in turn suitable for this filtration. Nonlinear morphological filters can also be used. Signal smoothing with an “anisotropic diffusion” filter is also conceivable. Such mechanisms are known, however, and can be implemented with discrete digital electronics, FPGA, and/or digital computers and software. Segmentation of the image into regions has an extremely large number of degrees of freedom. Because of this complexity, the general principle will be briefly explained here. The general purpose of segmentation tasks is subdivision of the image into different regions, and essentially a purely mathematical formalism. The image can be represented on the microscope's display by way of a first region, and thereby defined. Formally, a homogeneity dimension y is always defined that assigns a value γ (I,R) to each region R and to the image I. Based on that model, a partition
{R₁,R₂, . . . R_{N}},
where R₁∪R₂∪ . . . ∪R_{N}=image area and R₁∩R₂∩ . . . ∩R_{N}={ } (empty set), and the property

$${\sum }_{i} γ ( I , {R}_{1} ) = minimum$$

(or equivalently, depending on the homogeneity dimension chosen,

$${\sum }_{i} γ ( I , {R}_{1} ) = maximum ) ,$$

is searched for among all the possibilities. There are two reasons for the large number of different possibilities: The homogeneity dimension γ is selected specifically for the task at hand. Because of the large number of search possibilities, many heuristics are used to simplify the search. For this reason, there are many different procedures for solving this problem. For fluorescence images from one spectral band, the solution is almost trivial: the histogram of the image or image region must be examined for several threshold values. This yields a homogeneity dimension dependent only on the intensities. In this application, a trimodal distribution and three intensity regions are to be expected. These regions must be searched for (by brute force or heuristically) in the histogram. In a one-dimensional space, suitable methods here include discriminance analysis, cluster analysis, clustering neural networks, Otsu variance minimization, Kullback information distance minimization, or local entropy maximization. The search must be pursued recursively until the desired trimodality is or is not confirmed. The homogeneity dimension can be constructed by simple interval comparison, and results directly in a binarized image containing only the regions. For fluorescence images having several spectral bands (channels), multivariate histograms are suitable. These are often referred to in Leica jargon as “cytofluorograms,” and are disclosed, for example, in the publication of Demandolx D., Davoust J., “Multicolor analysis and local image correlation in confocal microscopy,” Journal of Microscopy, Vol. 185, Pt. 1, January 1997, pp. 21-36. The same mechanism as described above can be generated by abandoning the assumption of trimodality in the multidimensional space, and extending the recursive search further. Good results can likewise be obtained for fluorescence images with several spectral bands (channels) by simply reducing the intensities to the signal energy and then applying capability 1. As a supplement to any desired segmentation algorithm, it is of course possible to use, from the set of regions, one suitable one that contains the marked position. The quality and implementability of this method depends enormously on the application and on the method itself. Multivariate factorial statistics (principal component analysis) and energy considerations can also be used to simplify spectral images and forward them to the capabilities outlined above.

For the essential adjustment operations, the outer envelope of a region discovered during segmentation is required. For that reason, a geometry must be discovered from the segmentation process, stored in a suitable code in a computer or electronic system, and processed using appropriate manipulation algorithms. For example, a zoom function of a microscope can generate only rectangular images. For star-shaped geometries, therefore, the enclosing rectangle must first be determined. Such algorithms are sufficiently familiar to one skilled in the art and will not be given special attention here. As a rule, they are extracted from the binarized image using contour-following algorithms. This is preferably done using a digital computer. Alternatives include scan-line-based algorithms that are also FPGA-capable. The requisite regions discovered in this fashion can be further refined with a variety of mechanisms such as active contours or “snakes.” According to the existing art, software must be used for this.

### BRIEF DESCRIPTION OF THE DRAWINGS

Further advantages and advantageous embodiments of the invention are the subject matter of the Figures below and their portions of the description. Specifically:

FIG. 1 schematically depicts a confocal microscope using the present invention;

FIG. 2 shows a specific embodiment of the screen layout in terms of the structures of interest for investigation and possible user inputs;

FIG. 3 shows a logical information-processing pipeline structure that can be implemented electronically or in software and continuously supplies an object description to the application software;

FIGS. 4a and 4b show the relationship between image information and object information;

FIG. 5 shows the relationship between objects at different image acquisition times;

FIG. 6 shows a grayscale coding of the allocation according to FIG. 5;

FIG. 7 is a visualization of the semantic difference between the invention and the existing art.

### DETAILED DESCRIPTION OF THE PREFERRED EMBODIMENTS

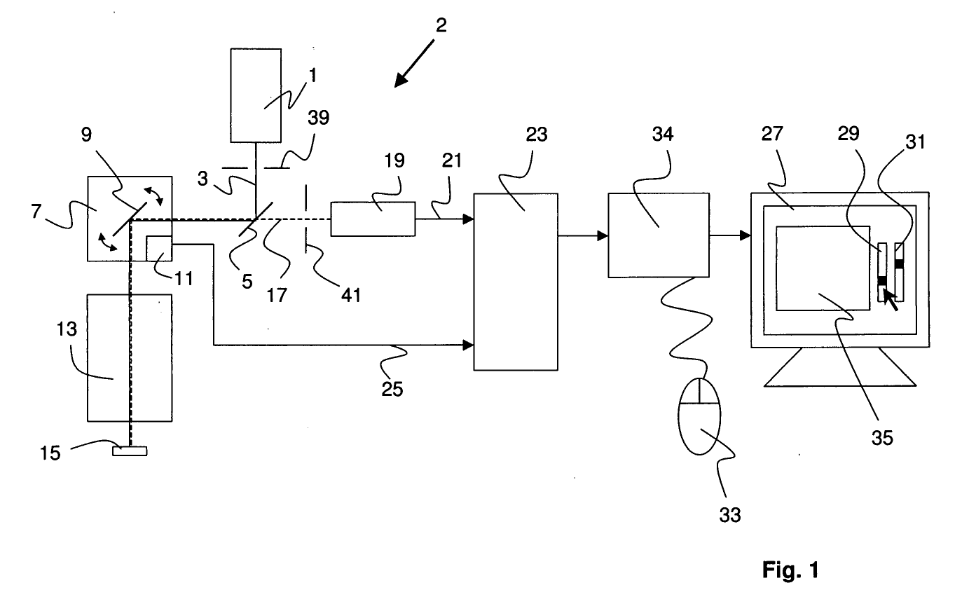

FIG. 1 schematically shows a confocal scanning microscope. The use of a confocal microscope here is to be understood as an example. It is sufficiently clear to one skilled in the art that the invention can also be carried out with other microscope architectures. Light beam 3 shown in FIG. 1 proceeds from an illumination system 1 and is reflected by a beam splitter 5 to scanning module 7, which has a gimbal-mounted scanning mirror 9 that guides the beam through microscope optical system 13 and over or through object 15. With non-transparent objects 15, the light beam is guided over the object surface. With biological objects 15 (preparations) or transparent objects, light beam 3 can also be guided through object 15. Object 15 can thus be scanned in various focal planes successively by light beam 3. Subsequent assembly of those planes then yields a three-dimensional image of the object.

Light beam 3 coming from illumination system 1 is depicted as a solid line. Light 17 proceeding from object 15 travels through microscope optical system 13 and via scanning module 7 to beam splitter 5, traverses the latter and strikes detector 19, which is embodied as a photomultiplier. Light 17 proceeding from object 15 is depicted as a dashed line. In detector 19, electrical detected signals 21 proportional to the power level of light 17 proceeding from the object are generated and forwarded to processing unit 23. Position signals 25 are sensed in the scanning module with the aid of an inductively or capacitatively operating position sensor 11, and transferred to processing unit 23.

The position of scanning mirror 9 can also be ascertained by way of the adjustment signals. The incoming analog signals are first digitized in processing unit 23. The signals are transferred to a computing unit, for example a PC 34, to which an input device 33 is connected. By means of input device 33, the user can make various selections relating to processing of the data. In FIG. 1, a mouse is depicted as an input device 33. Any other input device, however, for example a keyboard, a joystick, voice input, and the like, can also be used as input device 33.

A display 27 depicts, for example, an image 35 of object 15. In addition, adjusting elements 29, 31 for image acquisition can also be depicted on display 27. In the embodiment shown here, adjusting elements 29, 31 are depicted as sliders. Any other configuration of the adjusting elements is possible, however. PC 34 forwards the corresponding data to processing unit 23. The position signals and detected signals are assembled in processing unit 23 as a function of the particular settings selected, and are shown on display 27. Sliders 29, 31 are referred to as “adjusting elements.” The form in which the adjusting elements are depicted on display 27 is immaterial for the invention. Illumination pinhole 39 and detection pinhole 41 that are usually provided in a confocal scanning microscope are schematically drawn in for the sake of completeness. Omitted in the interest of better clarity, however, are certain optical elements for guiding and shaping the light beams. These are sufficiently familiar to the person skilled in this art.

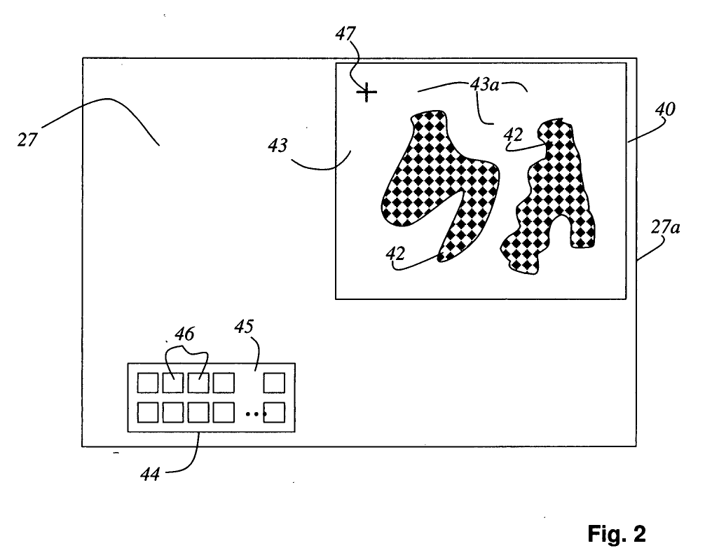

One possible, although minimal, form of screen display is shown in FIG. 2. Display 27 defines a screen edge 27a. A first region 40, in which image 43 of object 15 is displayed for the user, is defined on display 27. The image of object 15 comprises, for example, at least one fluorescing structure 42 that stands out clearly from a background 43a. Depicted in a second region 44 on display 27 are a selection of function buttons constituting a so-called panel box 45, with which various functions can be selected by the user. Each of the selectable buttons has, for example, a button 46 allocated to it. The mouse cursor is represented on display 27 by, for example, a crosshairs 47. The user can call the desired function, for example, using the mouse cursor. In addition, likewise using the mouse cursor, the user can select a desired structure 42 of image 43.

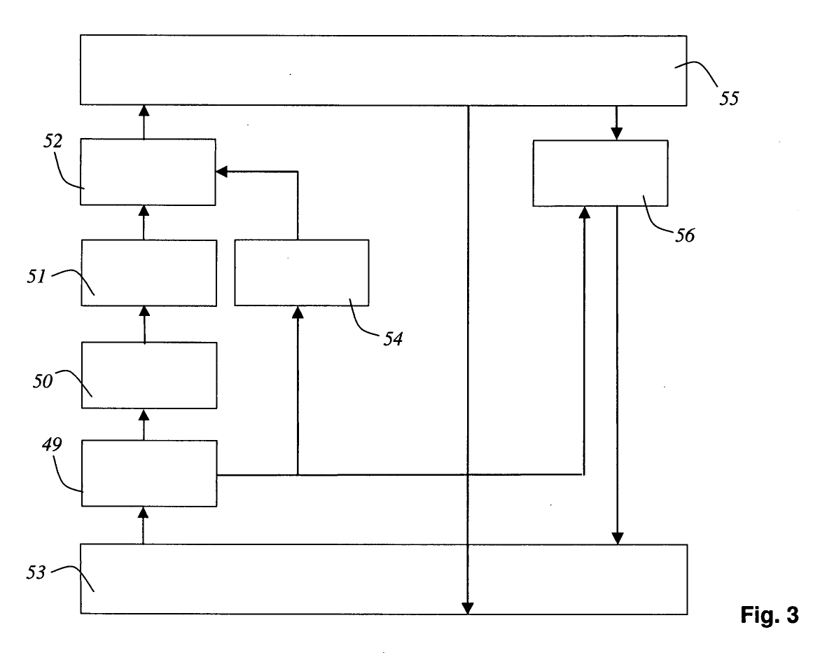

FIG. 3 shows the schematic configuration of the proposed system. The instances indicated can be implemented alternatively in software, in FPGA or DSP technology, or as electronic components. Control electronics 53 of the microscope system are directly controlled by application software 55 in accordance with the current existing art. This is also the case in the method and associated arrangement aimed at here; slightly different details will be discussed below. During operation, control electronics 53 supply image data that are managed in an imaging component 49. As already discussed, image production in the confocal system is accomplished, after selection of the region of interest by the user, by sequential collection of information from individual locations of the object, these being assembled into images, volumes, time series, etc. The division between imaging component 49 and the control electronics is arbitrary. The information collected in imaging component 49 is conveyed to a segmenting instance 50, i.e. a device for segmentation according to certain criteria, which performs a segmentation of the data. Individual segmented regions can then therefore be distinguished. The output of this stage corresponds to a number of segmented pixel groups with detailed information about the type of pixels, so that segmentation can ultimately be regarded as the identification of pixel groups that are to be allocated to a specific criterion. A device or further instance for labeling (not shown) can then be provided, in which context individual populations of pixels are distinguished. This information must be transferred into a suitable code which alone describes the geometry of the identified region. This is effected by geometry instance 51 alone. The resulting geometry describes the object outline. Further object information can be extracted by the fact that a special instance for Object Properties 54 extracts further object information from the image region defined by the geometry. A final instance, Object Representation 55, collects these individual information items, assembles them into a object description, and makes them available to an application software program. An additionally introduced bootstrap manager 56 can ensure that the system is transferred into an initially image-producing state. Only then does the information-processing pipeline, starting with imaging, automatically begin.

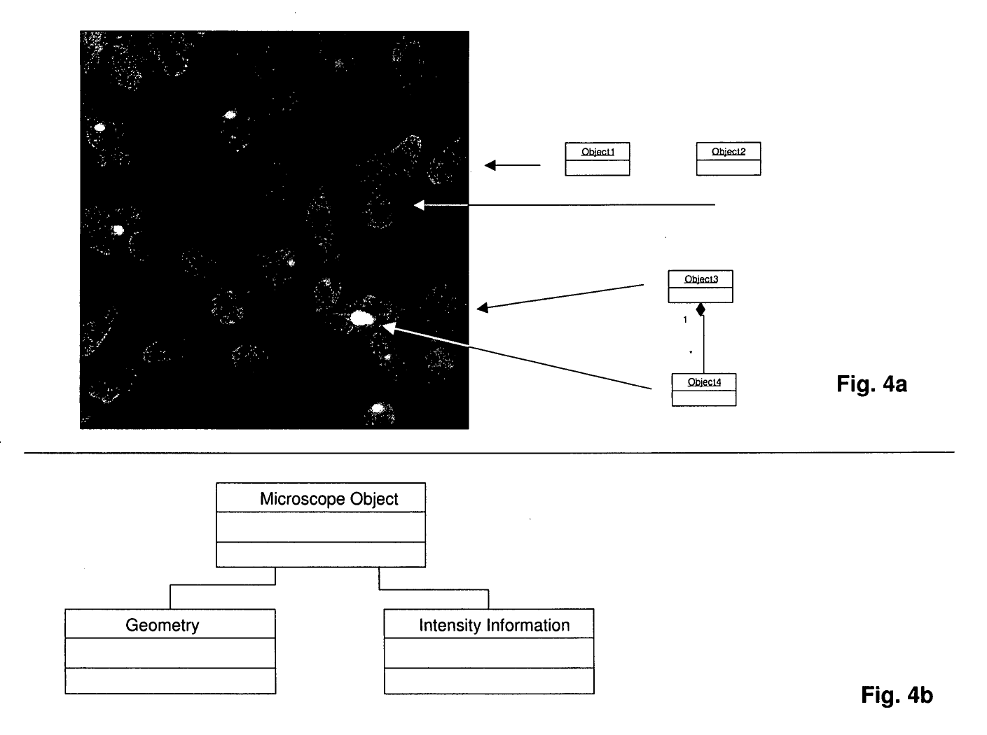

FIGS. 4a and 4b show the relationship between the image data coming from imaging instance 49 and the object data coming from Object Representation. FIG. 4a shows the relationship between individual visible objects and class structures (modeled in Unified Modeling Language [UML]). It should also be noted that hierarchical descriptions are also occasionally possible. FIG. 4b shows one possible object-oriented class description in UML that encompasses the geometrical data and intensity-based data.

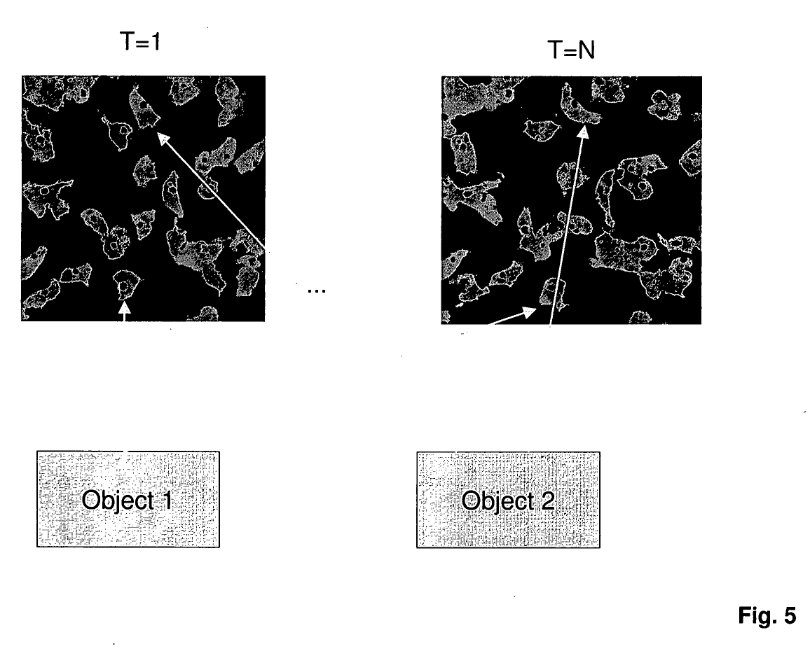

FIG. 5 shows a semantic advantage for the user, taking the example of two images that were acquired at different times T=1 and T=N. The identification information for objects 1 and 2 can be accomplished on the basis of the object information that has been discovered.

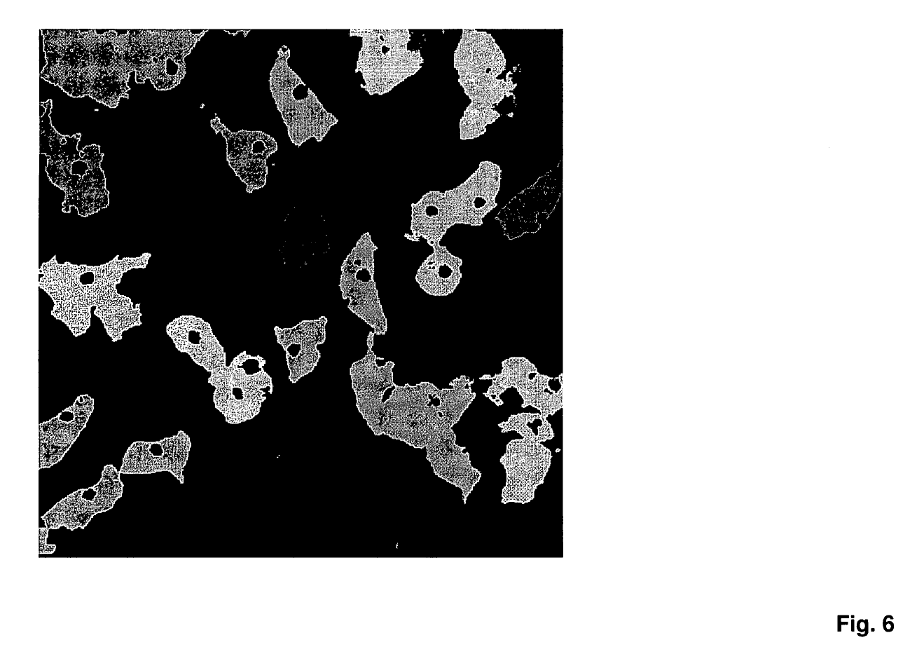

FIG. 6 shows a grayscale coding that visualizes these allocations.

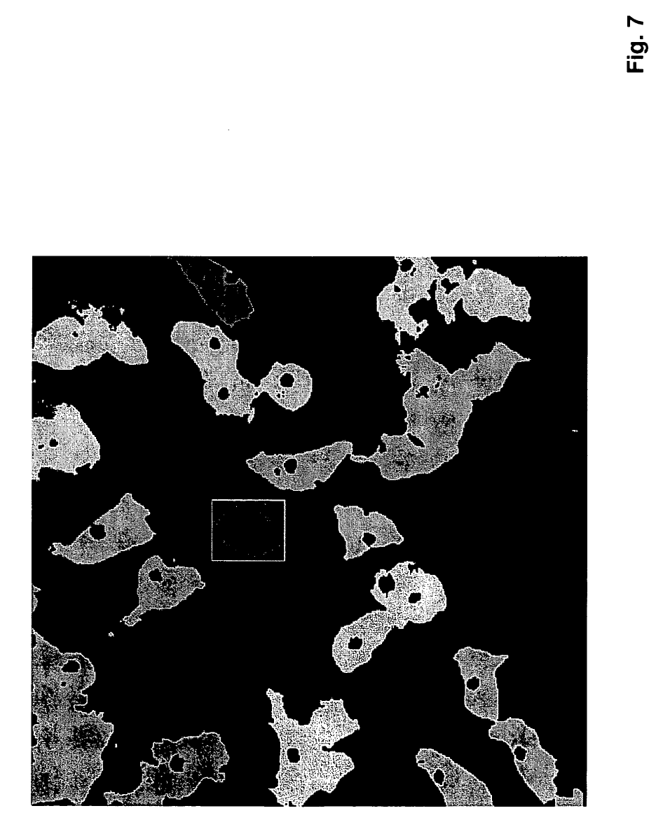

FIG. 7 visualizes the semantic difference between the existing art and the invention. Whereas in the existing art a system function (such as a zoom) must be modified, according to the invention an object from the object pool can be identified by way of a mouse click or a list selection, and the command “Show detail” can be issued. Both actions, when correctly applied, do the same thing; but the latter one does not force the user to depart from his or her mental world picture and learn to operate the microscope.

The application software knows the object and knows the geometrical extent and local fluorescence, and can allocate these individual parameters to the individual system components. For example, it can control the galvanometer control system of a confocal microscope in such a way that only the object is “painted.” The essential difference in terms of cognitive adaptation lies substantially in how the request is formulated.

The invention has been described with reference to a particular exemplary embodiment. It is self-evident, however, that changes and modifications can be made without thereby leaving the range of protection of the claims below.

1. An arrangement for controlling and operating a microscope, in particular for analysis and adjustment operations, the arrangement comprises:
a plurality of detectors for converting optical signals into electrical signals;
a unit for image acquisition;
a segmentation unit for segmenting the images into individual regions, in particular according to color, intensity, or texture;
a unit for labeling the regions;
a geometry unit for separating the segmented and optionally labeled image into individual geometries;
a unit for generating an object-oriented description of the regions, wherein the units being coupled to one another in such a way that the object-oriented representation of the regions is accomplished automatically in accordance with a defined stipulation of the user.

2. The arrangement as defined in claim 1, wherein the object-oriented description is accomplished with the aid of area center points or main axes.

3. The arrangement as defined in claim 1, wherein the object-oriented description is accomplished with the aid of area center points and main axes.

4. The arrangement as defined in claim 1, wherein a display is provided for depicting a superimposition of the acquired image and the object-oriented description.

5. The arrangement as defined in claim 1, wherein the units are coupled to one another in such a way that selection of an object in particular with a mouse click, constituting a defined stipulation of the user, triggers automatic creation of the object-oriented description.

6. The arrangement as defined in claim 1, wherein the segmentation unit generates pixel groups with defined conditions.

7. The arrangement as defined in claim 1, wherein an object unit is provided for extracting further object data.

8. The arrangement as defined in claim 1, wherein a bootstrap manager is provided for transferring the system into an initially image-producing state.

9. A method for controlling and operating a microscope, in particular analysis and adjustment operations, comprises the steps of:
providing a user input according to which an image of an object is automatically depicted;
segmenting individual regions according to color intensity, or texture;
optionally labeling the segmented regions; and
creating an object-oriented representation of the regions.

10. The method as defined in claim 9, wherein the labeled regions are divided into individual geometries.

11. The method as defined in claim 9, wherein pixel groups with defined conditions are generated upon segmentation.

12. The method as defined in claim 9 wherein further object data are extracted in an object unit.

13. The method as defined in claim 9, wherein the user input is the selection of an image region or the activation of a bootstrap manager that transfers the system into an initially image-producing state.

14. A software program on a data medium for controlling and operating a microscope,
wherein upon a defined stipulation of a user, the following processes are automatically performed:
imaging;
segmentation;
optionally, labeling;
object-oriented representation.

15. The software program on a data medium as defined in claim 14, wherein for segmentation, pixel groups with defined conditions are generated.

16. The software program on a data medium as defined in claim 14, wherein further object data are extracted in a further automatically performed process.

17. The software program on a data medium as defined in claim 14, wherein the system can be transferred, in particular with the aid of a bootstrap manager, into an initially image-producing state.
